(19) United States
(12) Patent Application Publication
(10) Pub. No.: US 2006/0162739 A1
(43) Pub. Date: Jul. 27, 2006

(54) Cleaning chuck in situ

(75) Inventor: Michael Sogard, Menlo Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Nikon Corporation, Tokyo (JP)

(21) Appl. No.: 11/330,314

(22) Filed: Jan. 10, 2006

Related U.S. Application Data
(60) Provisional application No. 60/646,051, filed on Jan. 21, 2005.

(51) Int. Cl. B08B 3/12; B08B 7/00; B08B 6/00; B08B 3/00

(52) U.S. Cl. 134/1; 134/6; 134/19; 134/94.1

(57) ABSTRACT

Embodiments of the invention provide a method and an apparatus for in situ chuck cleaning, which advantageously reduces downtime to restore flatness. In one embodiment, a method of cleaning a chuck in situ comprises providing a cleaning layer on a substrate, the cleaning layer comprising a deformable material; positioning the substrate to place the cleaning layer in contact with a chuck surface of the chuck in situ, the chuck surface having thereon a material to be removed from the chuck surface; pressing the cleaning layer against the chuck surface with a sufficient pressure to allow the material on the chuck surface to be attached to the cleaning layer; and removing the substrate with the cleaning layer and the material attached thereto from the chuck.

### CROSS-REFERENCES TO RELATED APPLICATIONS

This application is based on and claims the benefit of U.S. Provisional Patent Application No. 60/646,051, filed Jan. 21, 2005, the entire disclosure of which is incorporated herein by reference.

### BACKGROUND OF THE INVENTION

The present invention relates generally to cleaning chucks and, more particularly, to methods and apparatus for in situ cleaning of chucks such as electrostatic chucks used in lithography systems.

An exposure apparatus is one type of precision assembly that is commonly used to transfer images from a reticle onto a semiconductor wafer during semiconductor processing. A typical exposure apparatus includes an illumination source, a reticle stage assembly that retains a reticle, an optical assembly (sometimes referred to as a projection lens), a wafer stage assembly that retains a semiconductor wafer, a measurement system, and a control system. The resist coated wafer is placed in the path of the radiation emanating from a patterned mask and exposed by the radiation. When the resist is developed, the mask pattern is transferred onto the wafer. In microscopy, extreme ultra violet (EUV) radiation is transmitted through a thin specimen to a resist covered plate. When the resist is developed, a topographic shape relating to the specimen structure is left.

To achieve precise processing and high throughput, a reticle that is clamped to a chuck should be extremely flat. This is particularly true for EUV lithography because the EUV illumination at the reticle is not telecentric. If the reticle patterned surface does not lie in a plane conjugate to the wafer plane, aberrations and distortion of the image at the wafer can occur. Therefore, the chuck cannot be allowed to accumulate particles or other kinds of material buildup on its surface during operation.

The reticle surface for EUV lithography should be flat to within approximately 50 nm. Previous studies have shown, however, that particles considerably larger than 50 nm may not affect the reticle very much. The reason is that a combination of deformation of both the particle and the mating surfaces of the chuck and reticle reduce the effect at the opposite reticle surface. A preliminary spec for maximum tolerable particle size from SEMI is approximately 1 μm.

A conventional approach to address the flatness issue is to check the chuck surface, either directly by examining the chuck surface or indirectly by inspecting the surface of the reticle. If the chuck surface has developed non-flat regions, the chuck will be removed from the tool and its surface restored to flatness. This can lead to considerable downtime. For instance, the downtime is significant for servicing the electrostatic chuck in EUV lithography, which has electrical and coolant connections as well as precise mechanical attachments. Additionally, EUV lithography is normally conducted in vacuum, so venting and pump down times must be added to the downtime. Moreover, small particles will be difficult to find and clean.

### BRIEF SUMMARY OF THE INVENTION

The present invention takes advantage of developments in the field of imprint lithography, which in turn relate to experience in the fields of stamping and embossing of plastics. In one version of imprint lithography, a wafer is coated with a liquid photopolymer and a transparent die is impressed into it. The photopolymer is then exposed to light of an appropriate wavelength through the die so that it becomes a solid. The die is then removed, leaving a polymer surface patterned with the features on the die surface. In other versions, the polymer is a solid initially, and combinations of pressure and heat are used to imprint the surface. Similar methods are used in the commercial process of stamping CDs. The important point is that the die pulls cleanly away from the polymer, with no residue from the polymer remaining on it, even if the die has very fine features on its surface. In fact, it has been reported that dies which initially are contaminated with particles or other buildup become cleaner as they repeatedly stamp polymer films. In imprint lithography, the die is coated with a very thin mold release layer to facilitate separation from the polymer.

Embodiments of the present invention provide a method and an apparatus for in situ chuck cleaning, which advantageously reduces downtime to restore flatness. A cleaning film is provided on a substrate such as a dummy reticle, and brought into contact with the surface of the chuck to remove any particles or material buildup from the chuck surface in situ. The cleaning film is deformable, and preferably softer than the particles or material to be removed from the chuck surface. The cleaning film may have some of the similar characteristics as films used in imprint lithography. For instance, the cleaning film may be made of a polymer material which can be heated to improve its ability to embed the particles or material to be removed.

In accordance with an aspect of the present invention, a method of cleaning a chuck in situ comprises providing a cleaning layer on a substrate, the cleaning layer comprising a deformable material; positioning the substrate to place the cleaning layer in contact with a chuck surface of the chuck in situ, the chuck surface having thereon a material to be removed from the chuck surface; pressing the cleaning layer against the chuck surface with a sufficient pressure to allow the material on the chuck surface to be attached to the cleaning layer; and removing the substrate with the cleaning layer and the material attached thereto from the chuck.

In some embodiments, the deformable material of the cleaning layer deforms around the material to be removed when pressed against the chuck surface to embed the material into the cleaning layer for removal from the chuck surface. The deformable material of the cleaning layer is softer than the material to be removed from the chuck surface. The chuck is an electrostatic chuck, and pressing the cleaning layer against the chuck surface comprises activating the electrostatic chuck to clamp the substrate with the cleaning layer onto the electrostatic chuck. The method may further comprise heating the cleaning layer. The cleaning layer may be heated in situ. The cleaning layer may comprise an adhesive material for adhering the material to be removed from the chuck surface to the cleaning layer. The method may further comprise providing the chuck surface with a surface material having a lower surface energy than the cleaning layer. Removing the substrate with the cleaning layer and the material attached thereto from the chuck comprises ejecting the substrate with the cleaning layer from the chuck.

In specific embodiments, the method further comprises repeating the steps of providing a cleaning layer on a substrate, positioning the substrate to place the cleaning layer in contact with a chuck surface of the chuck in situ, pressing the cleaning layer against the chuck surface, and removing the substrate with the cleaning layer and the material attached thereto from the chuck. Repeating the steps may comprise providing a different cleaning layer. Repeating the steps may comprise providing a different substrate having a differently shaped substrate surface on which the cleaning layer is provided.

In accordance with another aspect of the invention, an apparatus for cleaning a chuck in situ comprises a substrate having provided thereon a cleaning layer which comprises a deformable material; a transport mechanism configured to position the substrate to place the cleaning layer in contact with a chuck surface of the chuck in situ, the chuck surface having thereon a material to be removed from the chuck surface; and a press mechanism to press the cleaning layer against the chuck surface with a sufficient pressure to allow the material on the chuck surface to be attached to the cleaning layer.

In some embodiments, the chuck is an electrostatic chuck, and the press mechanism comprises an electrostatic mechanism provided by the electrostatic chuck. The substrate includes a heating member to heat the cleaning layer. The cleaning layer comprises an adhesive material for adhering the material to be removed from the chuck surface to the cleaning layer. The substrate has a substrate surface on which the cleaning layer is provided, the substrate surface being selected from the group consisting of a flat surface, a convex surface, and a concave surface. The substrate comprises a dummy reticle.

### BRIEF DESCRIPTION OF THE DRAWINGS

FIG. 1 is a simplified schematic view of an in situ chuck cleaning apparatus being transported to the chuck for in situ cleaning according to an embodiment of the present invention.

FIG. 2 is a simplified schematic view of the in situ chuck cleaning apparatus of mechanism showing the in situ cleaning step.

FIG. 3 is a simplified schematic view of the in situ chuck cleaning apparatus being withdrawn from the chuck after the in situ cleaning step.

FIG. 4 is a plot illustrating the relationship between the approximate pressure of particle on polymer film for embedding particle and the particle size.

FIG. 5a is a schematic view of a particle embedding mechanism in which the entire force on the film is developed through the particle; and FIGS. 5b and 5c are schematic views of a particle embedding mechanism in which a part of the film is in direct contact of the film.

FIG. 6a is a schematic view of a particle embedding mechanism showing film material flow around the embedded particle; and FIG. 6b is a schematic view of an embedded particle with a release agent on the polymer surface.

FIG. 7 is a schematic view of an apparatus showing a reticle shield producing gas flow to isolate the projection optics chamber from gaseous contaminants outgassing from the reticle stage and surroundings.

FIG. 8 is a simplified schematic view of an EUV lithography system according to an embodiment of the invention.

### DETAILED DESCRIPTION OF THE INVENTION

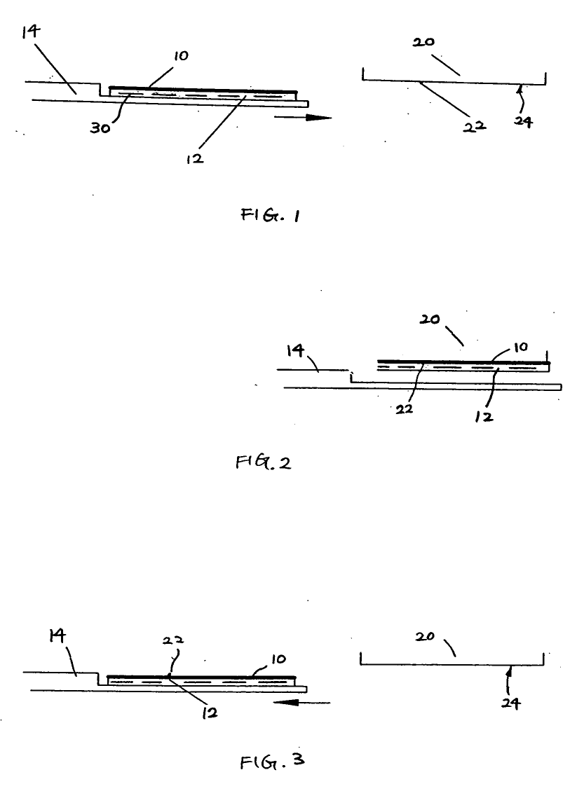

FIG. 1 shows a cleaning film or layer 10 disposed on a substrate such as a “dummy” reticle 12 which is placed on a transport mechanism such as an end effector 14. The cleaning film 10 may be provided on the substrate 12 by forming thereon or attaching thereto using any suitable technique, including deposition, molding, plating, bonding, joining, and the like. The end effector 14 may be one that is normally used to deliver an actual process reticle to the chuck for clamping. FIG. 1 shows a chuck 20 with a particle 22 disposed at the bottom surface 24 thereof.

In FIG. 2, the end effector 14 moves the dummy reticle 12 with the cleaning film 10 below the bottom surface 24 of the chuck 20, and the dummy reticle 12 is clamped to the chuck 20 with the cleaning film 10 placed in contact with the bottom surface 24 of the chuck 20. If the chuck 20 is an electrostatic chuck, the electrostatic clamping feature may be activated to clamp or press the dummy reticle 12 with the cleaning film 10 to the bottom surface 24 of the chuck 20, and then deactivated for release. For a conventional Coulombic electrostatic chuck, the cleaning film 10 will serve as a dielectric layer between the chuck 20 and the corresponding electrode provided in the dummy reticle 12. Alternatively, a different press mechanism (e.g., a mechanical actuator or the like) may be provided to press the dummy reticle 12 with the cleaning film 10 against the bottom surface 24 of the chuck 20 with a sufficient pressure to allow the particle 22 to be attached to the cleaning film 10. Or the end effector 14 may press the dummy reticle 12 with the cleaning film 10 against the chuck 20.

In FIG. 3, the dummy reticle 12 with the cleaning film 10 is released from the chuck 20, and is removed by the end effector 14. The particle 22 has transferred from the bottom surface 24 of the chuck 20 to the cleaning film 10. Using this approach, particles or other types of material buildup previously attached to the bottom surface 24 of the chuck 20 can be removed after being embedded or otherwise attached to the cleaning film 10. This technique is believed to be effective in removing particles and material buildup arising from transfer of materials between one or more reticles and the chuck. It may be less effective in removing buildup associated with chemical reactions or the like.

The cleaning film 10 desirably is a deformable film made of a soft material. In a preferred embodiment, the cleaning film material is softer than the particles to be cleaned from the bottom surface 24 of the chuck 20. For example, the cleaning film material may have a lower hardness than the particles. Examples of suitable materials for forming the cleaning film 10 include polymers, inorganic films, soft metals, and the like. If the cleaning film 10 is to be subjected to heat, polymers that contain volatile hydrocarbons or water vapor may not be ideal due to possible hydrocarbon outgassing that can be deleterious for UV optics. In that case, inorganic films with low vapor pressures and soft metals may be more suitable.

If the chuck 20 is an electrostatic chuck of the Johnsen-Rahbek type, such as described in G. Kalkowski et al, Electrostatic chucks for lithography applications, Microelectronic Engineering Vol. 57-58, 219(2001), the contents of which are incorporated herein by reference, the surface of the cleaning film 10 must be electrically conductive. Therefore a soft metal may be appropriate for the cleaning film 10.

In some cases, the cleaning film 10 may include a rubber-like material having an adhesive property that allows the particles and materials to be picked up by the film 10 more readily. An adhesive film is distinguished from other cleaning films by binding particles to it with little or no local deformation and embedding of the particle in the film. In that case, it is desirable for the bottom surface 24 of the chuck 20 to have a surface that does not tend to adhere to the cleaning film 10 to facilitate separation of the cleaning film 10 from the bottom surface 24. The bottom surface 24 may be coated with a release agent, such as a mold release agent, or a layer that has a low surface energy; or the chuck 20 may be made of a material having a low surface energy, such as polytetrafluoroethene (PTFE). The bottom surface 24 will have a lower surface energy than the cleaning film 10, so that particles or materials will more likely be adhered to the cleaning film 10 than to the bottom surface 24. General release agent properties are described, for example, in U.S. Pat. No. 6,309,580.

Whether the bottom surface 24 of the chuck 20 is treated with mold release or not, removing the dummy reticle 12 with the cleaning film 10 from the bottom surface 24 may be difficult without additional help. Many electrostatic chucks have built-in ejection mechanisms which push the reticle away from the chuck to enhance removal (e.g., ejector pins as described in U.S. Pat. No. 5,815,366, the entire disclosure of which is incorporated herein by reference). The dummy reticle 12 may include its own built-in ejection mechanism to ensure separation (e.g., by vacuum pressure, mechanical separation mechanism, or the like). Alternatively, the end effector 14 may be configured to pull the dummy reticle 12 away from the chuck 20.

The dummy reticle 12 may have the same configuration as the actual process reticle, or a different configuration. For example, the dummy reticle 12 may be thinner and thus more compliant and easily conformable to the surface of the chuck 20 for improved surface contact Alternatively, the dummy reticle 12 may be convex toward the chuck 20, so that it is initially clamped at the center. The clamping then spreads outward and minimizes rubbing of the two surfaces as the clamping force is applied. In yet another embodiment, given the compliant nature of the cleaning film 10, it may be desirable to provide a concave dummy reticle surface toward the chuck 20 so as to maximize rubbing of the two surfaces as the clamping force is applied. This may enhance capturing or embedding of the particles or materials by the deformable cleaning film 10.

Temperature control may be provided to enhance particle embedding by the cleaning film 10 and removal of materials from the bottom surface 24 of the chuck 20. For instance, a thermal plastic polymer may be heated to or above its glass transition temperature T_{g} (e.g., about 70° C. above T_{g}) to lower the viscosity of the cleaning film so that the material tends to flow more readily for embedding small particles and buildup. The deformation is somewhat elastic in the glass state below T_{g}, and is increased rather significantly in the rubbery state above T_{g}. This procedure has proved useful in nanoimprint lithography. In that regard, the dummy reticle 12 may be provided with a heating member 30 (e.g., heating coil or the like) to heat the cleaning film 10 in situ. In another embodiment, the cleaning film 10 may be heated a prior and then brought into contact with the bottom surface 24 of the chuck 20.

A higher pressure applied to the cleaning film 10 against the bottom surface 24 of the chuck 20 will also enhance its ability to capture or embed particles and buildup. The local pressure adjacent the particles or buildup will be quite high (e.g., in the MPa range) even if the global pressure applied to the cleaning film is relatively low (e.g., in the kPa range).

Although heating the cleaning film 10 may enhance its particle embedding abilities, it may not be necessary to do so in general or only a slight increase in temperature may be sufficient. For polymers, the temperature does not necessarily need to be above or even close to the glass transition temperature T_{g}. This is particularly true if the high local pressure is sufficient to embed or capture the particles or buildup.

After the cleaning treatment, the bottom surface 24 of the chuck 20 may be examined for any remaining buildup or particles. Alternatively, another reticle may be clamped to the bottom surface 24 of the chuck 20 and its flatness checked. For instance, a height monitoring apparatus may be provided for measurement.

A single application of the method may remove all or most of the particles from the bottom surface of the chuck. If desired or necessary, multiple applications may be employed to remove any remaining particles or buildup. The same cleaning film may be used in repeated clamping, or a plurality of cleaning films may be successively used. The cleaning films may be formed of the same material or of different materials. In addition, the multiple applications may involve the use of different dummy reticles (e.g., flat, concave, convex, etc.).

As discussed above, the dummy reticle is introduced into the processing system such as a lithography system using the same handling apparatus used for the actual process reticles. One or more dummy reticles may reside in locations in the in-tool reticle library if desired. Moreover, to remove particles from the cleaning film or recover cleaning performance of the dummy reticle, the cleaning film disposed on the dummy reticle may be exchangeable or replaceable. Alternatively, the dummy reticle may be washable to remove particles.

Using a polymer film to embed and remove particles from the chuck has analogies to nano-imprinting, but there are some important differences. The polymer film is either pressed onto the chuck, or the film, with a conducting back plate, is attached to the chuck by electrostatic attraction. In either case, pressures will probably not exceed 15 kPa, the SEMI spec, and may be significantly less. In contrast, the recommended pressure for nano-imprinting is approximately 5 MPa, for polymers at temperatures well above the glass transition temperature Tg. This might suggest that embedding of particles cannot happen, but local pressures developed at the particle can be much higher than the average chuck pressure, as demonstrated by the University of Wisconsin particle crushing studies and mentioned above.

If the chuck pressure is Pch and the chuck area is A, then the total attractive force on the film is F=Pch A. If a particle separates the film from the chuck surface, it experiences the entire chucking force. If the cross sectional area of the particle is a, then the local pressure Pp of the particle on the film is approximately Pp=F/a=Pch A/a. Since the particle is much smaller than the chuck, the local pressure is much higher than the average chucking pressure. FIG. 4 shows this relation, for two average chuck pressures, 1 kPa and 10 kPa. Even for particles as large as 100 μm the local pressure developed between the particle and the film exceeds the imprinting pressure by orders of magnitude, so embedding a particle in the film using conventional chucking pressures should be possible.

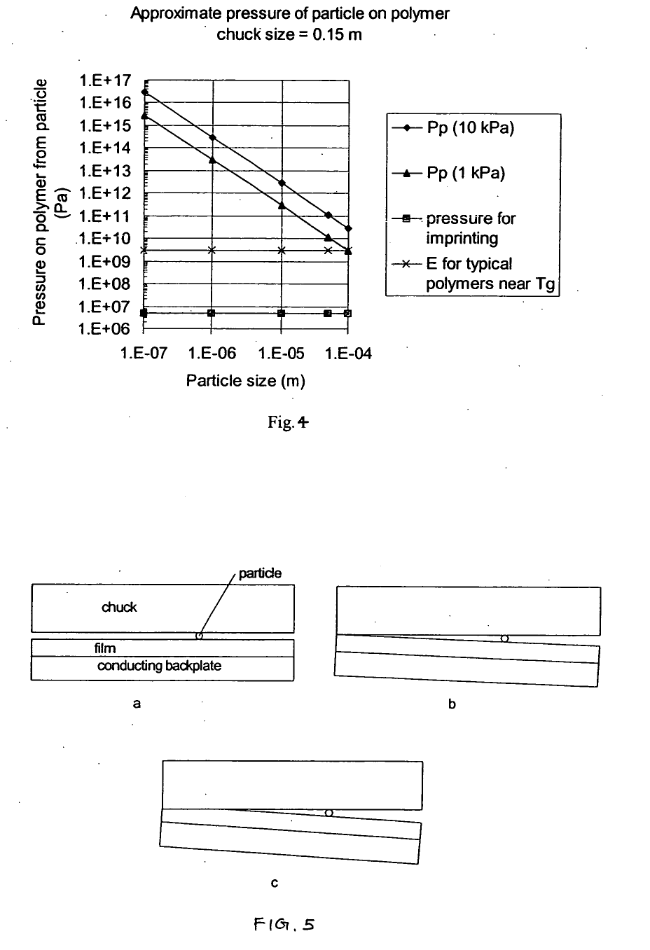

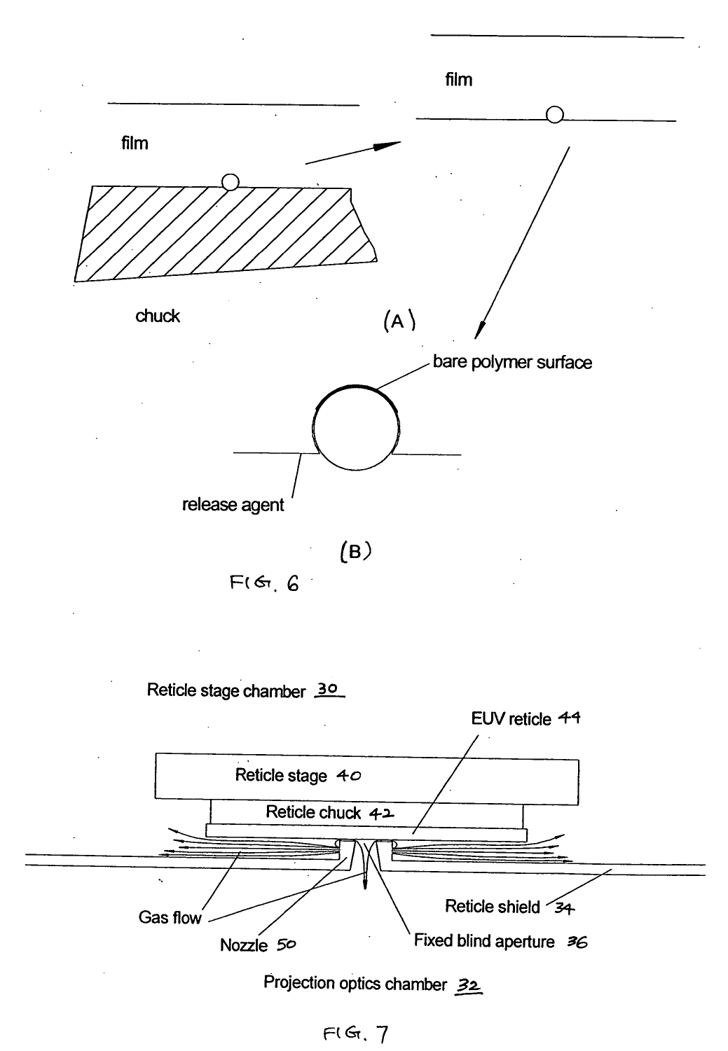

This analysis is based on the assumption that the entire force on the film is developed through the particle, the case shown in FIG. 5a. More realistic situations, particularly for the smaller particles, are illustrated in FIGS. 5b and 5c, where part of the film is in direct contact with the chuck, and the particle feels only a fraction of the total force. However, from FIG. 4, even if the residual force on the particle is only a fraction of a percent, the local pressure at the particle still exceeds that specified for imprinting.

Therefore, particles should be embedded in the film under normal or even weaker chucking conditions. Nano-imprinting typically is done with the polymer film at temperatures exceeding the glass transition temperature Tg; a value of Tg+80° C. is specified. Near Tg the elastic modulus E is approximately 3 GPa for most polymers. Above Tg, E decreases and plastic deformation of the polymer starts, and by Tg+80° C. a plastic flow condition is reached. Heating the polymer to high temperatures in the EUV vacuum is not desirable because of hydrocarbon and water outgassing concerns. However, some polymers have Tg<room temperature, and, as FIG. 4 shows, the local pressures achieved during cleaning can greatly exceed E(Tg), so it seems likely that embedding can occur for temperatures closer to Tg than in the nano-imprint case. Therefore cleaning at approximately room temperature may be possible.

The use of a mold release agent on the chuck surface is described above to avoid the film sticking to the chuck surface. Conceivably the lower surface energy provided by the release agent may lower the probability of particles sticking to the chuck in the first place. This would be a major advantage and might eliminate the need for subsequent chuck cleaning. Preferably, the mold release agent is compatible with the chuck material, and it can resist wear from friction between the chuck surface and the reticle. Moreover, the mold release agent is preferably stable over time in vacuum, with no outgassing, and is preferably radiation resistant.

The problems of hydrocarbon and water outgassing can be avoided if the release agent is applied on the surface of the polymer instead of the chuck. However, the effect of the release layer on particle embedding should be considered. If the particle is truly embedded, with the film material flowing around it, it is likely to remain with the film, even if the surface interaction energy between film and particle is low. This situation is illustrated in FIG. 6a. If the polymer material flows around the particle, the particle should be held even if the surface interaction energy between particle and film is low. However, the area of the film in contact with the surface of the particle is significantly greater than the film area initially encountered by the particle as it penetrates the film's surface. Since most release agents under consideration are monomolecular layers, the increased surface area common to both the particle and the film should be largely free of the release agent, and a normal amount of adhesion should exist, as seen in FIG. 6b. Therefore particles may be successfully held in the film even if a release agent is used.

The use of a thin polymer film to clean the chuck of particles may introduce some gaseous hydrocarbons into the reticle chamber, especially if the film is to be heated. If the hydrocarbons get into the projection optics chamber, they could degrade the projection optics mirror reflectivities. One technique of partially isolating the projection optics chamber and the reticle stage chamber during auto focus calibration is by closing a set of EUV illumination limiting blinds. See U.S. patent application Ser. No. 11/266,839, filed Nov. 4, 2005, the entire disclosure of which is incorporated herein by reference.

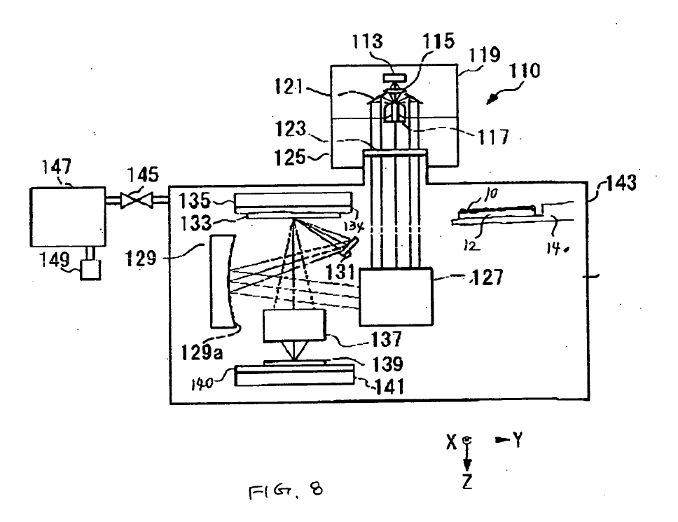

Another way to protect the EUV projection optics from contamination employs gas flow from nozzles in the reticle chamber to isolate the projection optics chamber from gaseous contaminants outgassing from the reticle stage and surroundings. FIG. 7 shows a reticle stage chamber 30 and a projection optics chamber 32 separated by a reticle shield (or fixed blind) 34 having a fixed blind aperture 36. Disposed in the reticle stage chamber 30 are the reticle stage 40, reticle chuck 42, and an EUV reticle 44. The shield 34 covers the reticle 44, except where it is illuminated by EUV, together with a nozzle 50 which generates a flow of gas parallel to the reticle surface. The gas flow drags particles with it, away from the reticle surface. This is sometimes referred to as viscophoresis. The gas expands and cools from the inlet, so that some thermophoretic protection is also provided. The nozzle 50 is part of the fixed blind assembly.

Some of the gas also flows between the reticle 44 and fixed blind 34 exiting through the fixed blink aperture 36 into the projection optics region 32. This provides some protection of the reticle 44 from particles in this area. The projection optics region 32 is maintained at a lower pressure than the reticle chamber 30, and the narrow gap between the reticle 44 and the fixed blink 34 serves as a differential pumping aperture. The higher pressure in the reticle chamber 30 is needed for effective viscophoresis and thermophoresis, and the lower pressure in the projection optics is needed for high transmission of the EUV radiation through the gas.

The projection optics mirror reflectivities are very sensitive to the hydrocarbon and water vapor contamination. Less than a monolayer absorbed on their surfaces can significantly reduce the reflectivity and therefore the lithography throughput. It is very difficult to completely eliminate materials and contamination from a stage, such as the reticle stage 40, so that outgassing of hydrocarbon or water from the reticle stage represents a threat to the mirror lifetime. With appropriate design the gas flow system described above and in FIG. 7 can largely contain outgassing from the reticle stage 40 and its surroundings within the reticle chamber 30 and thus protect the projection optics mirrors. The containment is achieved partly by the differential pumping between the two chambers, but primarily by the gas flows from the nozzle 50 which prevent outgassing from the reticle 44 from getting to the fixed blind aperture 36 and thus to the projection optics.

The effectiveness of the gas flow has been analyzed using gas dynamic modeling of the flows according to two studies. The first study shows that outgassing of CH₄ from the side of the reticle stage is largely confmed to the vicinity of the stage. The concentration of CH₄ is reduced by over two orders of magnitude near the face of the reticle. When the gas flow is turned off, the CH₄ then diffuses through out the region between the reticle and reticle shield within a few milliseconds. Because of the pressure differential between the reticle and projection optics chambers, some amount of purging of the CH₄ entering the projection optics occurs, but the situation is far inferior to that with the gas flow present.

In the second study, the reticle stage is moved to one end of its motion, bringing the outgassing region closer to the fixed blink aperture. Containment of the CH₄ outgassing to the reticle chamber remains effective. The concentration of CH₄ in the projection optics chamber is reduced by more than at least two orders of magnitude. The simulation uses a Monte Carlo program, and the finite number of test molecules used limits the smallest concentration which can be measured. The simulation results in the projection optics chamber represents less than 1 test molecule per interaction cell.

In the above studies, the fixed blind aperture was assumed to represent the only channel between the two chambers. Other openings can exist in the reticle shield, for alignment microscopes and the interferometer fixed mirror, for example. The gas flow keeps the contamination away from the reticle shield, so little transport of contamination through these openings is expected. In addition, even in the absence of the gas flow, if the conductances between the two chambers associated with these other openings are small compared to that at the fixed blind aperture, their outgassing contribution can probably be ignored.

The gas flow at the nozzle is shown in the plane of FIG. 7. Additional gas flows from the ends of the nozzle (above and beneath the plane of the figure) will provide additional isolation. In addition to protecting the projection optics, this scheme offers protection to the illumination optics as well.

A more detailed description of the reticle stage chamber with nozzles is provided in U.S. patent application Ser. No. 10/898,475, filed Jul. 23, 2004, the entire disclosure of which is incorporated herein by reference. The contaminants are eventually pumped out of the system through the reticle stage chamber vacuum pumps. A similar strategy, imposed during chuck cleaning, should keep any hydrocarbons generated from the projection optics chamber. More specifically, one may close the blinds or otherwise isolate the projection optics chamber from the reticle stage chamber during chuck cleaning.

FIG. 8 shows an EUV (or soft-X-ray SXR) lithography system 110, including the chuck cleaning apparatus of this invention as described above. As a lithographic energy beam, the EUV system 110 uses a beam of EUV light of wavelength λ=13 nm. The depicted system is configured to perform microlithographic exposures in a step-and-scan manner.

The EUV beam is produced by a laser-plasma source 117 excited by a laser 113 situated at the most upstream end of the depicted system 110. The laser 113 generates laser light at a wavelength within the range of near-infrared to visible. For example, the laser 1 13 can be a YAG laser or an excimer laser. Laser light emitted from the laser 113 is condensed by a condensing optical system 115 and directed to the downstream laser-plasma source 117. Upon receiving the laser light, the laser-plasma source 117 generates SXR (EUV) radiation having a wavelength (λ) of approximately 13 nm with good efficiency.

A nozzle (not shown), disposed near the laser-plasma source 117, discharges xenon gas in a manner such that the discharged xenon gas is irradiated with the laser light in the laser-plasma source 117. The laser light heats the discharged xenon gas to a temperature sufficiently high to produce a plasma that emits photons of EUV light as the irradiated xenon atoms transition to a lower-potential state. Since EUV light has low transmittance in air, the optical path for EUV light propagating from the laser-plasma source 117 is contained in a vacuum chamber 119 normally evacuated to high vacuum. Since debris normally is produced in the vicinity of the nozzle discharging xenon gas, the vacuum chamber 119 desirably is separate from other chambers of the system.

A parabolic mirror 121, coated with a Mo/Si multilayer film, is disposed relative to the laser-plasma source 117 so as to receive EUV light radiating from the laser-plasma source 117 and to reflect the EUV light in a downstream direction as a collimated beam. The multilayer film on the parabolic mirror 121 is configured to have high reflectivity for EUV light of which λ=approximately 13 nm.

The collimated beam passes through a visible-light-blocking filter 123 situated downstream of the parabolic mirror 121. By way of example, the filter 123 is made of Be, with a thickness of 0.15 μm. Of the EUV radiation reflected by the parabolic mirror 121, only the desired 13-nm wavelength of radiation passes through the filter 123. The filter 123 is contained in a vacuum chamber 125 evacuated to high vacuum.

An exposure chamber 143 is disposed downstream of the filter 123. The exposure chamber 143 contains an illumination-optical system 127 that comprises a condenser mirror and a fly-eye mirror (not shown, but well understood in the art). The illumination-optical system 127 also is configured to trim the EUV beam (propagating from the filter 123) to have an arc-shaped transverse profile. The shaped “illumination beam” is irradiated toward the left in the figure.

A circular, concave mirror 129 is situated so as to receive the illumination beam from the illumination-optical system 127. The concave mirror 129 has a parabolic reflective surface 129a and is mounted perpendicularly in the vacuum chamber 143. The concave mirror 129 comprises, for example a quartz mirror substrate of which the reflection surface is machined extremely accurately to the desired parabolic configuration. The reflection surface of the mirror substrate is coated with a Mo/Si multilayer film so as to form the reflective surface 129a that is highly reflective to EUV radiation of which λ=13 nm. Alternatively, for other wavelengths in the range of 10-15 nm, the multilayer film can be of a first substance such as Ru (ruthenium) or Rh (rhodium) and a second substance such as Si, Be (Beryllium) or B₄C (carbon tetraboride).

A mirror 131 is situated at an angle relative to the concave mirror 129 so as to received the EUV beam from the concave mirror 129 and direct the beam at a low angle of incidence to a reflective reticle 133. The reticle 133 is disposed horizontally so that its reflective surface faces downward in the figure. Thus, the beam of EUV radiation emitted from the illumination-optical system 127 is reflected and condensed by the concave mirror 129, directed by the mirror 131, and focused don the reflective surface of the reticle 133.

The reticle 133 includes a multilaycr film so as to be highly reflective to incident EUV light. A reticle pattern, corresponding to the pattern to be transferred to a substrate 139, is defined in an EUV-absorbing layer formed on the multiplayer film of the reticle 133, as discussed later below. The reticle 133 is mounted via a reticle chuck 134 on a reticle stage 135 that moves the reticle 133 at least in the Y direction. The reticle 133 normally is too large to be illuminated entirely during a single exposure “shot” of the EUV beam. As a result of the mobility of the reticle stage 135, successive regions of the reticle 133 can be irradiated sequentially so as to illuminate the pattern in a progressive manner with EUV light from the mirror 131.

A projection-optical system 137 and substrate (such as a semiconductor wafer) 139 are disposed in that order downstream of the reticle 133. The projection-optical system 137 comprises multiple multilayer-film reflective mirrors that collectively demagnify an aerial image of the illuminated portion of the pattern on the reticle 133. The demagnification normally is according to a predetermined demagnification factor such as ¼. The projection-optical system 137 focuses an aerial image of the illuminated pattern portion onto the surface of the substrate 139. Meanwhile, the substrate 139 is mounted via a wafer (substrate) chuck 140 on a substrate stage 141 that is movable in the X, Y, and Z directions.

Connected to the exposure chamber 143 via a gate valve 145 is a preliminary-evacuation (“load-lock”) chamber 147. The load-lock chamber 147 allows exchanges of the reticle 133 and/or substrate 139 as required. The load-lock chamber 147 is connected to a vacuum pump 149 that evacuates the load-lock chamber 147 to a vacuum level substantially equal to the vacuum level inside the exposure chamber 143.

During a microlithographic exposure, EUV light from the illumination-optical system 127 irradiates the reflective surface of the reticle 133. Meanwhile, the reticle 133 and substrate 139 are moved by their respective stages 135 and 141 in a synchronous manner relative to the projection-optical system 137. The stages 135 and 141 move the reticle 133 and the substrate 139, respectively, at a velocity ratio determined by the demagnification factor of the projection-optical system 137. Thus, the entire circuit pattern defined don the reticle 133 is transferred, in a step-and-scan manner, to one or more “die” or “chip” locations on the substrate 139. By way of example, each “die” or “chip” on the substrate 139 is a square having 25-mm sides. The pattern is thus “transferred” from the reticle 133 to the substrate at very high resolution (such as sufficient to resolve a 0.07-μm line-and-space (L/S) pattern). So as to be imprintable with the projected pattern, the upstream-facing surface of the substrate 139 is coated with a suitable “resist.”

In the system 110 of FIG. 8, the dummy reticle 12 (or dummy wafer) with cleaning film 10 and the end effector 14 are used for cleaning reticle chuck 134 (or wafer chuck 140) in situ.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A method of cleaning a chuck in situ, the method comprising:
providing a cleaning layer on a substrate, the cleaning layer comprising a deformable material;
positioning the substrate to place the cleaning layer in contact with a chuck surface of the chuck in situ, the chuck surface having thereon a material to be removed from the chuck surface;
pressing the cleaning layer against the chuck surface with a sufficient pressure to allow the material on the chuck surface to be attached to the cleaning layer; and
removing the substrate with the cleaning layer and the material attached thereto from the chuck.

2. The method of claim 1 wherein the deformable material of the cleaning layer deforms around the material to be removed when pressed against the chuck surface to embed the material into the cleaning layer for removal from the chuck surface.

3. The method of claim 1 wherein the deformable material of the cleaning layer is softer than the material to be removed from the chuck surface.

4. The method of claim 1 wherein the chuck is an electrostatic chuck, and wherein pressing the cleaning layer against the chuck surface comprises activating the electrostatic chuck to clamp the substrate with the cleaning layer onto the electrostatic chuck.

5. The method of claim 1 further comprising heating the cleaning layer.

6. The method of claim 5 wherein the cleaning layer is heated in situ.

7. The method of claim 1 wherein the cleaning layer comprises an adhesive material for adhering the material to be removed from the chuck surface to the cleaning layer.

8. The method of claim 7 further comprising providing the chuck surface with a surface material having a lower surface energy than the cleaning layer.

9. The method of claim 8 wherein the surface material is compatible with a chuck material of the chuck to resist wear from friction between the chuck surface and the substrate.

10. The method of claim 7 further comprising providing a chuck material for the chuck which has a lower surface energy than the cleaning layer.

11. The method of claim 1 wherein removing the substrate with the cleaning layer and the material attached thereto from the chuck comprises ejecting the substrate with the cleaning layer from the chuck.

12. The method of claim 1 further comprising repeating the steps of providing a cleaning layer on a substrate, positioning the substrate to place the cleaning layer in contact with a chuck surface of the chuck in situ, pressing the cleaning layer against the chuck surface, and removing the substrate with the cleaning layer and the material attached thereto from the chuck.

13. The method of claim 12 wherein repeating the steps comprises providing a different cleaning layer.

14. The method of claim 12 wherein repeating the steps comprises providing a different substrate having a differently shaped substrate surface on which the cleaning layer is provided.

15. The method of claim 1 further comprising providing a release agent on a surface of the cleaning layer to which the material on the chuck surface is to be attached.

16. The method of claim 1 further comprising isolating a region which includes optics from a region which includes the chuck during cleaning of the chuck.

17. An exposure method comprising:
cleaning a chuck in situ according to claim 1;
supporting a reticle on the cleaned chuck; and
irradiating the reticle to form an image of the reticle on a wafer.

18. An exposure apparatus comprising:
cleaning a chuck in situ according to claim 1;
supporting a wafer on the cleaned chuck; and
irradiating a reticle to form an image of the reticle on the wafer.

19. An apparatus for cleaning a chuck in situ, the apparatus comprising:
a substrate having provided thereon a cleaning layer which comprises a deformable material;
a transport mechanism configured to position the substrate to place the cleaning layer in contact with a chuck surface of the chuck in situ, the chuck surface having thereon a material to be removed from the chuck surface; and
a press mechanism to press the cleaning layer against the chuck surface with a sufficient pressure to allow the material on the chuck surface to be attached to the cleaning layer.

20. The apparatus of claim 19 further comprising an ejection mechanism to assist in removing the cleaning layer from the chuck surface.

21. The apparatus of claim 19 wherein the deformable material of the cleaning layer deforms around the material to be removed when pressed against the chuck surface to embed the material into the cleaning layer for removal from the chuck surface.

22. The apparatus of claim 19 wherein the deformable material of the cleaning layer is softer than the material to be removed from the chuck surface.

23. The apparatus of claim 19 wherein the chuck is an electrostatic chuck, and wherein the press mechanism comprises an electrostatic mechanism provided by the electrostatic chuck.

24. The apparatus of claim 19 wherein the substrate includes a heating member to heat the cleaning layer.

25. The apparatus of claim 19 wherein the cleaning layer comprises an adhesive material for adhering the material to be removed from the chuck surface to the cleaning layer.

26. The apparatus of claim 19 wherein the substrate has a substrate surface on which the cleaning layer is provided, the substrate surface being selected from the group consisting of a flat surface, a convex surface, and a concave surface.

27. The apparatus of claim 19 wherein the substrate comprises a dummy reticle.

28. The apparatus of claim 19 wherein a release agent is provided on a surface of the cleaning layer to which the material on the chuck surface is to be attached.

29. The apparatus of claim 19 further comprising an isolating mechanism disposed between a region which includes optics from a region which includes the chuck to isolate the optics from the chuck during cleaning of the chuck.

30. An exposure apparatus comprising:
an apparatus for cleaning a chuck in situ as recited in claim 19;
a reticle to be supported on the cleaned chuck; and
an optical system configured to form an image of the reticle on a wafer.

31. An exposure apparatus comprising:
an apparatus for cleaning a chuck in situ as recited in claim 19;
a wafer to be supported on the cleaned chuck; and
an optical system configured to form an image on the wafer.
